(19) United States
(12) Patent Application Publication
(10) Pub. No.: US 2014/0054123 A1
(43) Pub. Date: Feb. 27, 2014

(54) Intermittent Bi-directional Driving Mechanism, Device for Preventing Reverse Motion Comprising Same and Anti-Reverse Motion Vehicle

(71) Applicants: Yabin GAN, Changsha, Hunan (CN); Jianguo GAN, Changsha, Hunan (CN)

(72) Inventor: Jianguo Gan, Changsha (CN)

(73) Assignee: Yabin, Changsha (CN)

(21) Appl. No.: 14/114,219

(22) PCT Filed: Mar. 28, 2012
(86) PCT No.: PCT/CN12/00395

§ 371 Date: Oct. 27, 2013

(30) Foreign Application Priority Data
Apr. 28, 2011 (CN) 201110107488.4

(51) Int. Cl. F16D 41/12

(52) U.S. Cl. CPC F16D 41/12
USPC 192/45.1; 192/41 R

(57) ABSTRACT

Disclosed is an intermittent bi-directional driving mechanism, which transmits rotating power in forward and reverse directions through a bi-directional driving wheel (4); during the start process after the rotating direction is changed, there is an intermittent pause for a driven wheel (5), during which period the actions of other parts can be completed. By utilizing the function of the intermittent pause of the bi-directional driving mechanism, a device for preventing reverse motion during a start from an uphill slope is provided herein. When a vehicle is moving in one of the four slope-driving states of forward on an uphill slope, forward on a downhill slope, reverse on an uphill slope, and reverse on a downhill slope, the device for preventing reverse motion gives the vehicle a reverse braking function when moving forward on an uphill slope, so that an anti-reverse motion vehicle is provided. The device for preventing reverse motion can improve the operating conditions of the driver, and ensures the transmission system of the vehicle runs stably and safely so as to reduce traffic accidents.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to an anti-reverse motion device and more particularly to the anti-reverse motion device with an intermittent bi-directional driving mechanism which is applied to an anti-reverse motion vehicle.

2. Description of Related Arts

In the mechanical transmission system, the conventional rotating motion is transference, and the rotating motion has two rotating directions, which is a clockwise rotating direction and an anticlockwise rotating direction, such that a reversing gear is usually applied to change the rotating direction. A conventional transmission system is a non-intermittent motion. In other words, the conventional transmission system is a continuous transference motion. That is to say, while the conventional transmission system stops its operation and then prepares to operate again, there is no intermittent stopping motion required within this process.

However, in order to use a mechanical transmission system with some special transference motion, a mechanical transmission system with an intermittent stopping moment is needed. For example, while a vehicle is driven on a ramp road or a muddy road, the intermittent stopping moment of the mechanical transmission system is required to solve anti-reverse motion problems of the vehicle, such that the mechanical transmission system with the intermittent stopping moment within the vehicle can selectively control the rotating motion thereof via an intermittent bi-directional driving mechanism.

Accordingly, the conventional mechanical transmission system is a continuous and repeated intermittent motion, such as a clock mechanism. Therefore, the intermittent bi-directional driving mechanism is needed to solve the anti-reverse motion while the vehicle is driven on a ramp road. In addition, when the rotating motion of the transmission system of the vehicle stops and prepares to restart again, driven components of the transmission system generate a temporary intermittent stopping moment, so that driving components are able to initiate additional motions within such intermittent stopping moment so as to achieve certain selective control abilities.

While the vehicle is driven and then is required to stop on an uphill road, the vehicle is subjected to gravity that forces the vehicle to slide backwardly, such that, in such manner, if the vehicle is driven to restart on an uphill road, it is more difficult than if the vehicle is driven to restart on a level road. Therefore, drivers are required to have better driving skills for driving on an uphill road.

In general, while the vehicle is driven on a ramp road, i.e. an uphill road and a downhill road, the drivers need to control actions of braking, putting the vehicle into gear, controlling an accelerator pedal, and controlling a clutch pedal, wherein the sequence and strength of above actions must be operated properly. If the sequence and strength of the above actions don't aren't correctly completed, there are two results which will happen, the flameout of the engine and the reverse motion of the vehicle. Therefore, while the vehicle is a heavy load and driven on the ramp road with a large slope, the reverse motion of the vehicle will generate and cause dramatic traffic accidents.

### SUMMARY OF THE PRESENT INVENTION

A main object of the present invention is to provide an intermittent bi-directional driving mechanism which can operate two rotating motions in opposite directions, wherein while the rotating motion stops and prepares to restart, driven components generate a temporary intermittent stopping moment; in other words, the driven components relatively stop within the temporary intermittent stopping moment.

Another object of the present invention is to provide an anti-reverse motion device with an intermittent bi-directional driving mechanism comprising an uni-directional braking mechanism and a linking control mechanism so as to selectively control the rotating motion of the bi-directional driving mechanism.

Another object of the present invention is to provide an anti-reverse motion device for an anti-reverse vehicle so as to simplify the operating actions of a restarting motion for the anti-reverse vehicle driving on a uphill road, and thereby avoid the flameout of the engine and the reverse motion of the vehicle.

Accordingly, an intermittent bi-directional driving mechanism comprises an input shaft, and an output shaft, and transmission components having a driving wheel, a driven wheel, wherein the driven wheel is fixedly connected to the input wheel, wherein the driven wheel is fixedly connected to the output shaft, wherein the driving wheel is coaxially mounted with the driven wheel; and

at least a set of bi-directional driving pawls arranged on the driving wheel able to swing around a position axis, wherein the driven wheel comprises tooth spaces at a position which is corresponding with the position of the bi-directional driving pawl for meshing with the bi-directional driving pawl while the bi-directional driving pawl swings from side to side.

In the intermittent bi-directional driving mechanism as mentioned above, in order to avoid a rotating speed of the driven wheel exceeding a rotating speed of the driving wheel, the transmission component comprises three locking units arranged between each set of the bi-directional driving pawl, and three sets of latch springs arranged between each locking unit and the driven wheel.

In the intermittent bi-directional driving mechanism as mentioned above, in order to avoid the driving wheel uncontrollably detaching from the driven wheel, while one pawl of a set of the bi-directional driving pawls completely meshes with one of a set of the tooth space, the other pawl of a set of the bi-directional driving pawls completely detaches from the other of a set of the tooth space. In other words, two of a set of the bi-directional driving pawls doesn't completely detach from each of a set of the tooth space at the same time.

In the intermittent bi-directional driving mechanism as mentioned above, the driving wheel is fixedly connected with the input shaft by the spline coupling, and the driven wheel is fixedly connected with the output shaft by the spline coupling.

Accordingly, an anti-reverse motion device further comprises a case, wherein the uni-directional braking mechanism and the linking control mechanism are arranged within the case.

In the anti-reverse motion device as mentioned above, wherein the anti-reverse motion device has a brake disk and a brake roller arranged between the brake disk and the case, wherein the brake disk has jaw linking teeth arranged thereon.

In the anti-reverse motion device as mentioned above, the linking control mechanism has the brake disk, a linking tooth, a return spring, and a push pin, wherein the push pin is installed within the driving wheel, wherein one of a set of bi-directional driving pawls has a slanted working surface which contacts with one end of the push pin, and the other end of the push pin contacts with the brake disk, wherein the return spring is arranged between the brake disk and the linking tooth.

In the anti-reverse motion device as mentioned above, the linking tooth has meshed jaw linking teeth with respect to the jaw linking teeth of the brake disk, and the linking tooth is fixedly connected with the driven wheel.

Accordingly, the anti-reverse motion device for the anti-reverse motion vehicle according to the preferred embodiment of the present invention comprises a vehicle frame, a driving shaft of the transmission, and a driving shaft of a driving axle.

In the anti-reverse motion device for the anti-reverse motion vehicle as mentioned above, the input shaft is connected with the driving shaft of the transmission of the vehicle, and the output shaft is connected with the driving axle of the vehicle, and the case of the anti-reverse motion device is fixedly arranged on a vehicle frame.

The present invention has the following advantages over the contemporary technology: the intermittent bi-directional driving mechanism according to the preferred embodiment of the present invention is a mechanical transmission system having a bi-directional driving pawl providing clockwise and anticlockwise rotation, wherein when the driving wheel rotates in one direction and starts to change to rotate from one direction to the opposite direction, the driven wheel doesn't immediately activate to rotate in the opposite direction by the driving wheel. At this moment, the bi-directional driving wheel is driven by the driving wheel for driving the driven wheel to rotate in the opposite direction. Therefore, the bi-directional driving pawl produces a temporary intermittent stopping moment, so as to operate additional motion and achieve certain selective control abilities.

In the anti-reverse motion device, while the bi-directional driving pawl is in the intermittent stopping moment, the push pin is pushed by the slanted working surface of one bi-directional driving pawl of a set of bi-directional driving pawls 4 so as to move the brake disk, such that the jaw linking teeth of the brake disk meshes with the meshed jaw linking teeth of the linking tooth of the driven wheel. Based on the brake disk and brake roller of the uni-directional braking mechanism, while the driven wheel connects with the brake disk, the output shaft is linking with the brake disk for providing a reverse braking function for the vehicle.

In the anti-reverse motion device for the anti-reverse motion vehicle, the anti-reverse device is installed between the driving shaft of the transmission and the driving shaft of the driving axle so as to achieve selective control of the vehicle moving on one of four driving states, moving forwardly on a uphill road, backwardly on a downhill road, backward on a uphill road, and backwardly on a downhill road. When the vehicle is driven to move forwardly on an uphill road, the rotation motion of the transmission mechanism which causes the vehicle to generate a reverse motion is blocked by a reverse braking function. While the vehicle is driven to move forwardly during the downhill, the direction of the gravity and the motion of the vehicle is the same, so there is no reverse motion being generated on the vehicle. While the vehicle is driven to move backwardly during the uphill and downhill road, the driving shaft of the driving axle is de-linking with the uni-directional driving mechanism arranged within the anti-reverse motion device, in such a manner that the restart motion of the anti-reverse vehicle is the same as the restart motion of the conventional vehicle.

Additional advantages and features of the invention is provided for an intermittent bi-directional driving mechanism of an anti-reverse motion device of the anti-reverse vehicle for preventing reverse motion so as to improve the operating conditions for the driver, and ensure the transmission system of the vehicle for operating steadily and safely so as to reduce traffic accidents.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a sectional view of an intermittent bi-directional driving mechanism according to a preferred embodiment of the present invention.

FIGS. 2 to 5 are A-A sectional view of an intermittent bi-directional driving mechanism according to the preferred embodiment of the present invention, illustrating transmission principle of thereof.

FIG. 6 is a perspective view of an intermittent bi-directional driving mechanism according to the preferred embodiment of the present invention.

FIG. 7 is a sectional view of an anti-reverse motion device for an anti-reverse motion vehicle according to the preferred embodiment of the present invention.

FIG. 8 is an A-A sectional view of FIG. 7 according to the preferred embodiment of the present invention.

FIG. 9 is a perspective view of an anti-reverse motion device for an anti-reverse motion vehicle.

FIG. 10 is a perspective view of an anti-reverse motion device for an anti-reverse motion vehicle, illustrating the anti-reverse motion device installed on the anti-reverse motion vehicle.

FIG. 11 is a perspective view of an anti-reverse motion device for an anti-reverse motion vehicle, illustrating a connection of the anti-reverse motion device and the anti-reverse motion vehicle.

FIG. 12 and FIG. 13 show an anti-reverse motion device for a medium-size truck.

### DETAILED DESCRIPTION OF THE PREFERRED EMBODIMENT

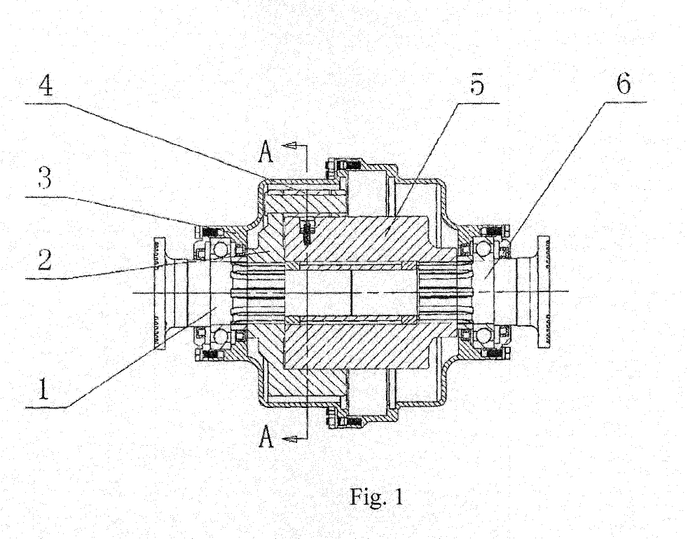

Referring to FIG. 1 of the drawings, the present invention is to provides an anti-reverse motion device for a vehicle according to a preferred embodiment of the present invention, wherein the anti-reverse motion device comprises an intermittent bi-directional driving mechanism which comprises a case 3 adapted for installing transmission to components therein, an input shaft 1 installed on one end of the case, and an output shaft 6 installed on the other end of the case 3. The transmission components comprise a driving wheel 2 fixedly connected with the input shaft 1, and a driven wheel 5 fixedly connected with the output shaft 6, wherein the connecting method can be a spline coupling, a flat key coupling, a bolting coupling, a jaw coupling, or a welding method. In the preferred embodiment, the connecting method is preferably the spline coupling, such that the driven wheel 5 is fixedly connected with the output shaft 6 by the spline coupling.

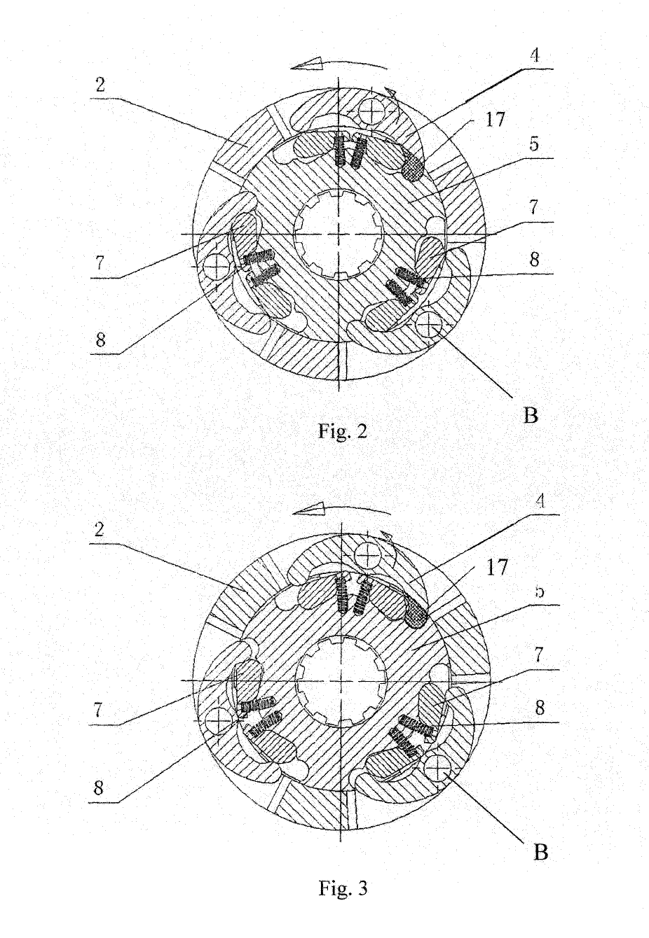

Referring to FIG. 2 of the drawings, the transmission components further comprise three sets of bi-directional driving pawl 4, wherein two of each set of bi-directional driving pawls 4 are symmetrically arranged along a position axis B and each set of three sets of bi-directional driving pawl is spacedly arranged along a circumference of the driving wheel 2, such that the bi-directional driving pawl 4 can be driven by the driving wheel 2 to operate a circular motion, so that two of each set of bi-directional driving pawls 4 can swing from side to side around a position axis B with respect to the bi-directional driving pawl 4. The driven wheel 5 is positioned within the driving wheel 2 comprising three sets of tooth spaces 17 at a position which is corresponding with the position of the three sets bi-directional driving pawl 4, such that while two of each set of the bi-directional driving pawl 4 swings from side to side, each set of the bi-directional driving pawl 4 can mesh with the each set of the tooth spaces 17.

Referring to FIG. 2 to FIG. 5 of the drawings, while the driving wheel 2 rotates anticlockwisely the bi-directional driving pawls 4 are driven to anticlockwise rotate in a circular motion, and in other words, the bi-directional driving pawl 4 starts to anticlockwise swing around the position axis B. Therefore, one of a set of the bi-directional driving pawl within the tooth spaces starts to detach therefrom of the driven wheel 5.

As shown in FIG. 3, while one of a set of the bi-directional driving pawl 4 which is positioned within one of a set of the tooth spaces 17 doesn't not completely detach from the tooth spaces 17, the other of a set of the bi-directional driving pawl 4 is partially enter into the other of a set of the tooth spaces 17.

As shown in FIG. 4, when the driving wheel 2 continuously anticlockwise rotates, the bi-directional driving pawls 4 will not mesh with any of the space tooth 17 of the driven wheel 5, in such manner that there is no driven force exerting on the driven wheel 5 such that the driven wheel 5 is on an intermittent stopping moment.

As shown in FIG. 5, while the driving wheel 2 continuously anticlockwise rotates after the intermittent stopping moment of the driven wheel 5, one of a set of the bi-directional driving pawl 4 which is positioned within one of a set of the tooth spaces 17 completely detaches from tooth spaces 17, the other of a set of the bi-directional driving pawl 4 partially enters into the other of a set of the tooth spaces 17. Therefore, the driven wheel 5 is driven to rotate along with the driving wheel 2. While the driving wheel 2 stops for starting the clockwise rotation, the bi-directional driving pawl 4 starts to a reverse motion of FIG. 2 to FIG. 5.

Accordingly, referring to FIG. 2 to FIG. 5 of the drawings, during the transition process that the bi-directional driving pawl 4 in an anticlockwise rotation starts to change to a clockwise rotation, one of each set of the bi-directional driving pawl 4 completely meshes or enters into the tooth spaces 17 of the driven wheel 5. In other words, two of a set of the bi-directional driving pawls 4 will not completely detach from the tooth spaces 17 at the same time. In order to avoid that the driving wheel 2 uncontrollably detached from the driven wheel 5, while one of each set of the bi-directional driving pawl 4 completely meshes with one of each set of the tooth space 17, the other of each set of the bi-directional driving pawl 4 completely detached from the other of each set of the tooth space 17.

In order to prevent the rotating speed of the driven wheel 5 to exceed the rotating speed of the driving wheel 2, the transmission component further comprises three locking unit 7 and each of the locking unit 7 is arranged between each of three sets of the bi-directional driving pawl 4, and three sets of latch springs 8. Each set of the latch springs 8 is arranged between each of the locking unit 7 and the driven wheel 5. While the centrifugal force generating from the rotation motion of the driven wheel 5 is able to overcome the pressure of the latch spring 8, the locking unit 7 outwardly stretches for holding the bi-directional driving pawl 4 in position so as to lock the bi-directional driving pawl 4 and the driven wheel 5 in a meshed position, such that the bi-directional driving pawl 4 can be insure to remain the same rotating direction during the transmission process. While the driven wheel 5 stops rotating, there is no centrifugal force generating for exerting on the locking unit 7, so the pressure of the latch spring 8 cannot be offset so that the locking unit 7 retracts back to its original position. Therefore, the bi-directional driving pawl 4 and the driven wheel 5 lose the meshed position, so the bi-directional driving pawl 4 is able to change the rotating direction.

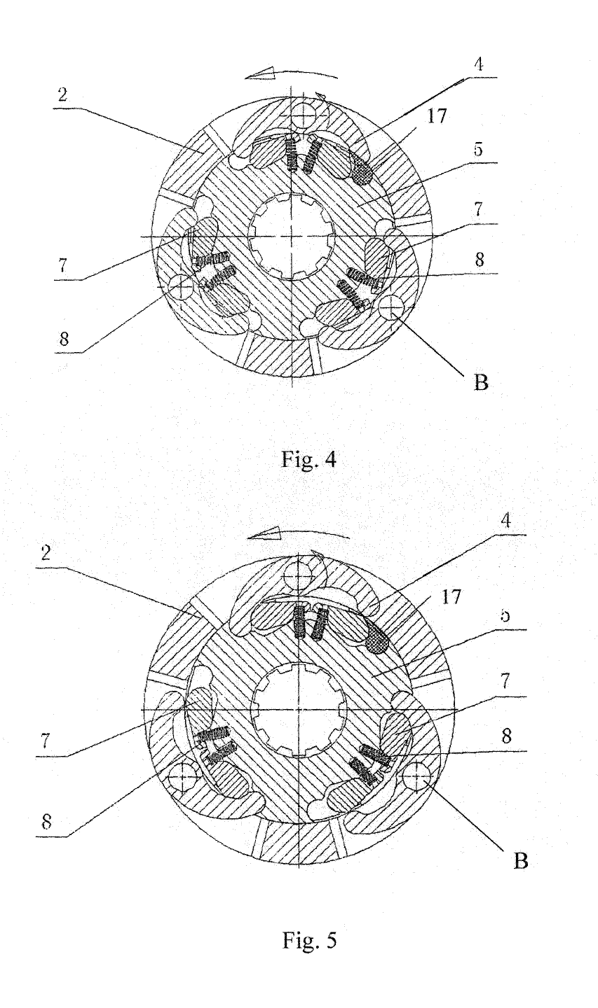

According to the preferred embodiment of the present invention, the anti-reverse motion device utilized an intermittent bi-directional driving mechanism, as shown in FIG. 6, which has the input shaft 1, the output shaft 6, the bi-directional driving pawl 4, the driving wheel 2, the driven wheel 5, the case 3, the locking unit 7, and the latch spring 8. The anti-reverse motion device further comprises a unidirectional braking mechanism and a linking control mechanism.

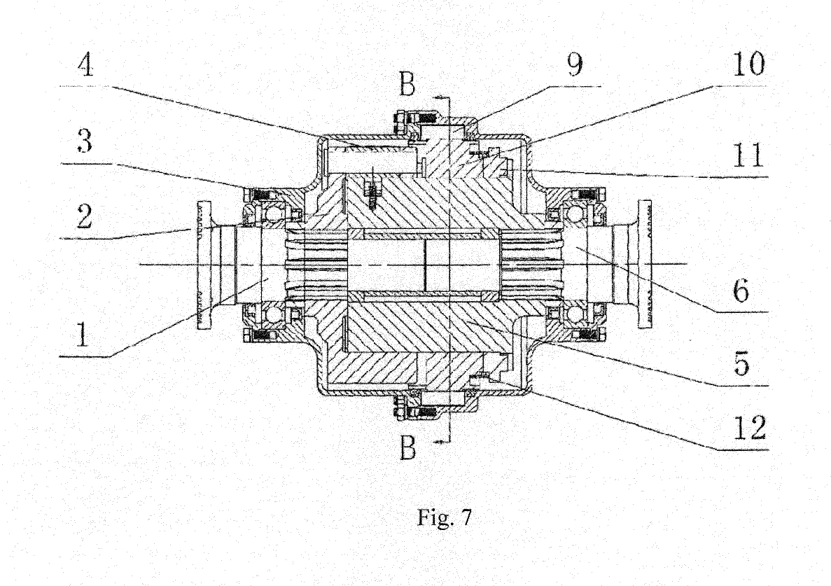

Accordingly, the unidirectional braking mechanism of the anti-reverse motion has a brake disk 10 and a brake roller 9 arranged between the brake disk 10 and the case 3. As shown in FIG. 8, while the brake disk 10 clockwise rotates, no braking force generates for the rotation motion of the brake disk 10, such that the brake roller 9 normally operates. While the brake disk 10 rotates anticlockwise, a cylindrical surface of the brake roller 9 contacts with brake disk 10 to generate a normal force for the brake disk and contacts with the case 3 also to generate a normal force for the case. Due to the angle of the normal force for the brake disk and the normal force for the case that is smaller than the angle of the friction force, the cylindrical surface of the brake roller 9 is self-locked within an inner surface of the case 3, and generates a brake force between the brake disk 10 and the brake roller 9. Therefore, the unidirectional braking mechanism is composed of the case 3, the brake roller 9, and the brake disk 10.

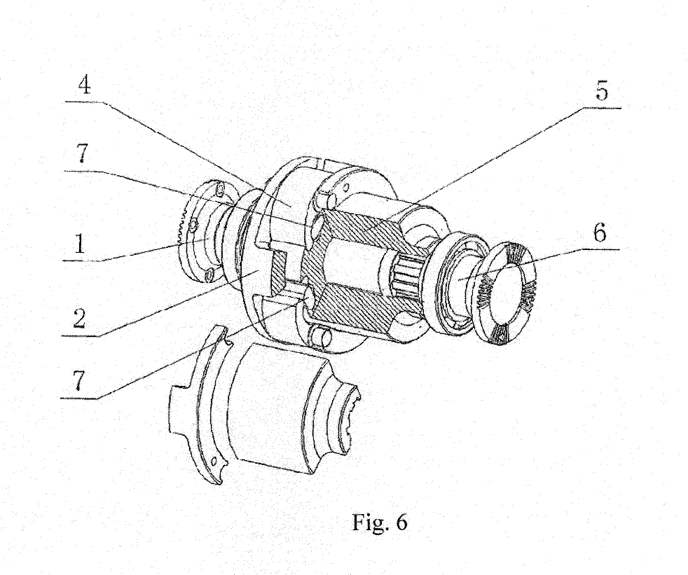

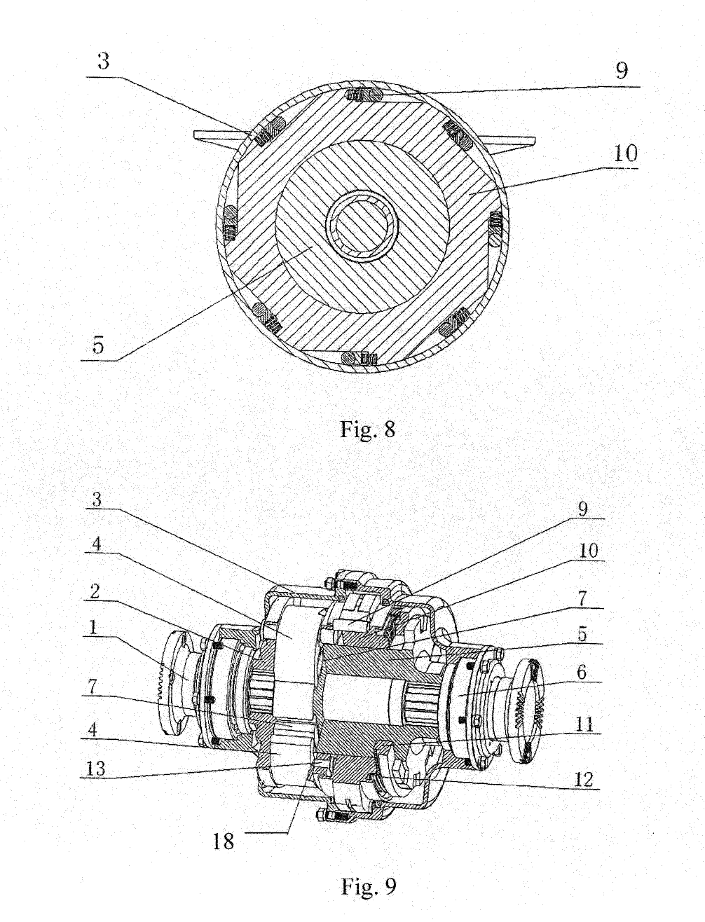

Accordingly, the linking control mechanism has the brake disk 10, a linking tooth 11, a return spring 12, and a push pin 13. As shown in FIG. 7 and FIG. 9, the brake disk 10 has a set of jaw linking teeth, and the linking tooth 11 has meshed jaw linking teeth with respect to the jaw linking teeth of the brake disk 10. In other words, the jaw linking teeth of the brake disk 10 meshes with the meshed jaw linking teeth of the linking tooth 11. The linking tooth 11 is fixedly connected with the driven wheel 5, in such manner that the connecting method can be a spline coupling, a flat key coupling, a bolting coupling, a jaw coupling, or a welding method. In the above preferred embodiment, the connecting method is preferably the jaw coupling, such that the driven wheel 5 is fixedly connected with linking tooth 11 by the jaw coupling.

Accordingly, one of a set of bi-directional driving pawl 4 has a slanted working surface which contacts with one end of the push pin 13, and the other end of the push pin 13 contacts with the brake disk 10, as shown in FIG. 9. According to the process for changing the rotating direction, as shown in FIG. 2 to FIG. 5 of the drawings, while the bi-directional driving pawl 4 anticlockwise swings from side to side around the position axis B as well as that the driven wheel 5 is in the intermittent stopping moment, the push pin 13 is pushed by the slanted working surface of one of a set of bi-directional driving pawl 4 so as to move the brake disk 10, such that the jaw linking teeth of the brake disk 10 meshes with the meshed jaw linking teeth of the linking tooth 11. Therefore, due to that the driven wheel 5 connects with the output shaft 6 and the driven wheel 5 is fixedly connected with the linking tooth 11, and the jaw linking teeth of the brake disk 10 is linking with the meshed jaw linking teeth of the linking tooth 11. Therefore, the output shaft 6 is linking with the brake disk 10 within unidirectional braking mechanism, and in other words, the output shaft is linking with the unidirectional braking mechanism.

As shown in FIG. 2, continuously, while the bi-directional driving pawl 4 clockwise swings around the position axis B from side to side, the push pin 13 loses pushing force from the bi-directional driving pawl 4, and then the return springs 12 is activated to move the brake disk 10, such that the jaw linking teeth of the brake disk 10 detaches from the meshed jaw linking teeth of the linking tooth 11, and in other words, the output shaft 6 is unlinking with the unidirectional braking mechanism.

According to the preferred embodiment of the present invention, while the vehicle is driven to move backwardly, the output shaft 6 is not linking with the brake disk 10 of the unidirectional braking mechanism, such that the vehicle is in a same driving condition as the conventional vehicle. In other words, the bi-directional driving pawl 4 clockwise swings around the position axis B from side to side.

While the vehicle is driven to move forwardly, the output shaft 6 is linking with the brake disk 10 of the unidirectional braking mechanism. While the vehicle is driven to move forwardly on a level ground road, the unidirectional braking mechanism doesn't need to produce the brake force to the brake disk 10 thereof for preventing the vehicle reversely moving. However, while the vehicle is driven to move forwardly on an uphill road, and prepare to be stopped, the output shaft 6 keeps linking with the brake disk 10 of the unidirectional braking mechanism. Therefore, while the vehicle is stopped on the uphill road, the vehicle has a gravity effect for forcing the vehicle to move reversely, so the unidirectional driving mechanism produces a brake force for blocking the reversely moving of the output shaft 6; in other words, there is no reverse motion happened on the vehicle.

It is worth mentioning that while the vehicle is in a stopped motion, and even if the transmission of the vehicle is in a gap position, there is no reverse motion happened for the vehicle due to the brake force of the unidirectional driving mechanism. After that, while the vehicle is continuously activated to move forwardly, the vehicle is activated to be at a moving situation that is the same as a moving situation which the vehicle is driven on the level ground.

Accordingly, while the vehicle is activated to move backwardly and the vehicle is in a reverse position, the bi-directional driving pawl 4 is activated to change to clockwise rotation, such that the push pin 13 is not pushed by the slanted working surface of the bi-directional driving pawl 4, and then the brake disk 10 is pushed by the return springs 12, in such manner that the linking tooth 11 of the driven wheel 5 detaches from the jaw linking teeth of the brake disk 10. Therefore, the output shaft 6 disconnects with the unidirectional driving mechanism, such that the unidirectional driving mechanism doesn't affect the backward motion of the vehicle.

Accordingly, the above mentioned preferred embodiment is provided to satisfy the required performance of the anti-reverse motion device of the vehicle.

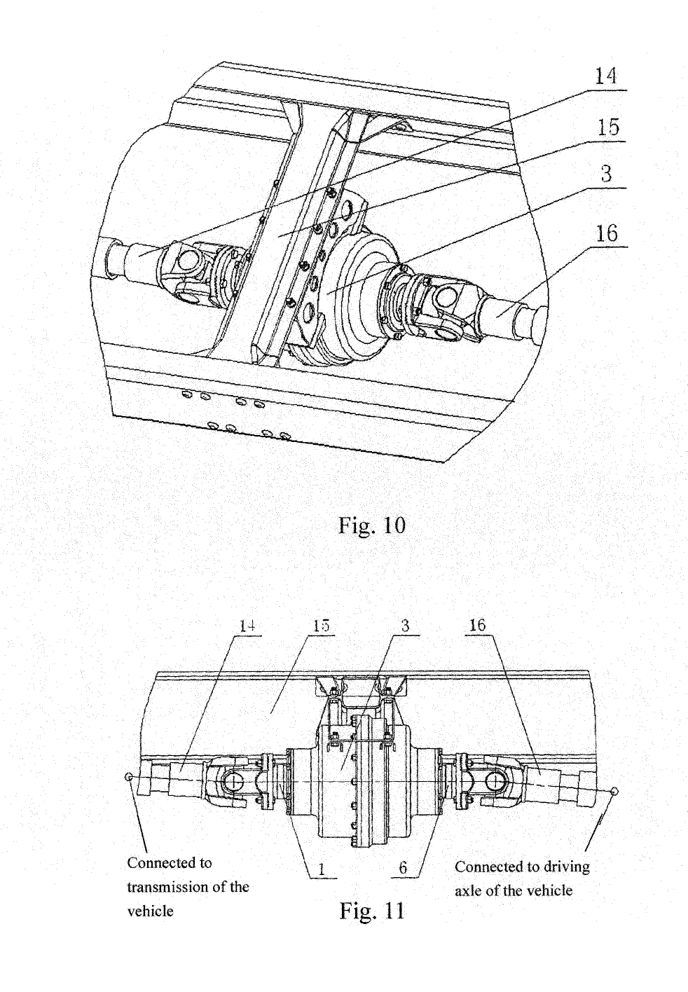

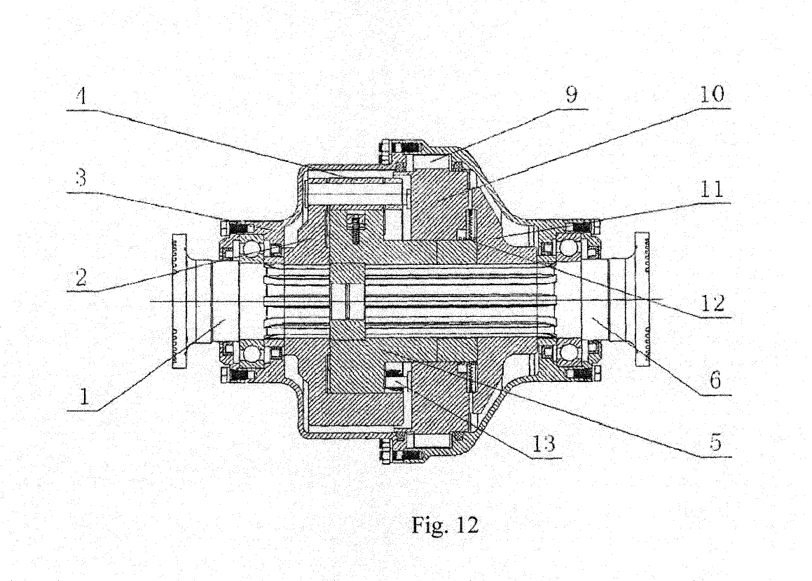

According to the preferred embodiment of the present invention, the anti-reverse motion device for the vehicle is installed within the transmission system of the conventional vehicle. As shown in FIG. 10 and FIG. 11, the anti-reverse motion device is installed between a driving shaft of the transmission 14 and a driving shaft for the driving axle 16, wherein the input shaft 1 is connected with a output of the transmission of the vehicle via the driving shaft of the transmission 14, and the output shaft 6 is connected with a input of the driving axle of the vehicle via the driving shaft for the driving axle 16, in such manner that the case 3 of the anti-reverse motion device is fixedly arranged on a vehicle frame 15.

Below is a combination of the FIG. 9 and the anti-reverse motion device for the anti-reverse vehicle to further describe the functional principles of the present invention.

As shown in FIG. 9, the driving wheel 2 is driven to rotate by the input shaft 1, and a set of the bi-directional driving pawl 4 is driven to rotate by the driving wheel 2, and then the driven wheel 5 is driven to do the clockwise and anti-clockwise rotation by the bi-directional driving wheel pawl 4.

While the driving wheel 2 anticlockwise rotates, the bi-directional driving pawls 4 is driven to anticlockwise rotate for operating the circular motion, so that each set of bi-directional driving pawls 4 swings from side to side around a position axis B of said set of the bi-directional driving pawls 4, in such manner that one of a set of the bi-directional driving pawl 4 gradually enters into the one of a set of tooth space 17 of the driven wheel 5 for meshing therein, such that the driven wheel 5 is driven to anticlockwise rotate.

Continuously, while the driving wheel 2 is activated to change to clockwise rotate, the bi-directional driving pawls 4 is driven to clockwise rotate for operating the circular motion, as well as that each set of bi-directional driving pawls 4 swings from side to side around a position axis B of such set of the bi-directional driving pawl 4, in such manner that one of a set of the bi-directional driving pawl 4 that meshed within one of a set of the tooth space 17 of the driven wheel 5 is detached therefrom, and the other of a set of the bi-directional driving pawl 4 gradually enters into the other of a set of tooth space 17 of the driven wheel 5 for meshing therein, such that the driven wheel 5 is driven to clockwise rotate.

FIG. 9 shows a situation that the vehicle is driven to move forwardly. One of a set of the bi-directional driving pawl 4 meshes with one of a set of tooth space 17 of the driven wheel 5, and the push pin 13 is pushed to the right side by the slanted working surface of the bi-directional driving surface 4, such that the jaw linking teeth of the brake disk 10 meshes with the meshed jaw linking teeth of the linking tooth 11 of the driven wheel 5. Therefore, the driven wheel 5 connects with the output shaft 6, and the linking tooth 11 is arranged on the driven wheel 5, such that the output shaft 6 is linking with the brake disk 10 of the unidirectional braking mechanism. Based on the brake disk 10, the brake roller 9, and a case 3 of the uni-directional braking mechanism, while the vehicle is driven to move forwardly on the uphill road and prepared to stop, there is no reverse motion of the drive shaft of the driving axle 16, as shown in FIG. 11. Therefore, the gravity of the vehicle and the external force can't cause the reverse motion of the vehicle.

Continuously, while the vehicle is activated to change to move backwardly, the vehicle needs to be stopped, set in a reverse position and started again. As shown in FIG. 9, the driving wheel 2 starts to clockwise rotate, and the bi-directional driving pawl 4 is driven to clockwise rotate by the driving wheel 2, such that one of a set of the bi-directional driving pawl 4 that meshed within one of a set of the tooth space 17 of the driven wheel 5 is detached therefrom, and the other of a set of the bi-directional driving pawl 4 meshes with the other of a set of tooth space 17 of the driven wheel 5. As to mentioned above, while the driven wheel 5 is on an intermittent stopping moment, the push pin 13 isn't be pushed by the bi-directional driving pawl 4, and then the brake disk 10 is pushed to move leftward by the return springs 12,as shown in FIG. 9, such that the jaw linking teeth of the brake disk 10 detaches from the meshed jaw linking teeth of the linking tooth 11 of the driven wheel 5, such that the output shaft 6 is de-linking with the brake disk 10 of the unidirectional braking mechanism. Therefore, due to the disconnection between the drive shaft of the driving axle 16 and the brake roller 9, the brake disk 10 and the case 3 of the unidirectional braking mechanism, there is no braking effect applied on the drive shaft of the driving axle 16 by the unidirectional braking mechanism.

Therefore, the anti-reverse motion device for the vehicle is installed between the driving shaft of the transmission 14 and the driving shaft of the driving axle 16 so as to selectively control the functions and performances as mentioned below:

The present invention can be applied to the four ramp driving conditions: driving to move backwardly and forwardly on the uphill road, and driving to move backwardly and forwardly on the downhill road. While the vehicle is driven to move forwardly on the uphill road, the drive shaft of the driving axle 16 is linking with the uni-directional driving mechanism arranged within the anti-reverse motion device so as to produce the braking effect to the drive shaft of the driving axle 16. Therefore, while the driving shaft of the driving axle 16 of the vehicle is forced to reversely rotate by the gravity of the vehicle, the braking function can be produced to solve the reverse motion of the vehicle. In addition, while the vehicle is driven to move forwardly on the downhill road, the driving shaft of the driving axle 16 is linking with the unidirectional driving mechanism arranged within the anti-reverse motion device. Due to the same direction of the gravity and the motion of the vehicle, there is no reverse motion on the vehicle.

While the vehicle is driven to move backwardly during the uphill and downhill road, the driving shaft of the driving axle 16 is de-linking with the uni-directional driving mechanism arranged within the anti-reverse motion device, in such a manner that the restarting motion of the anti-reverse vehicle is the same as the conventional vehicle.

While the vehicle is driven to move forwardly on the level ground road and prepares to temporarily stop, the power source from the transmission is stopped and the reverse motion of the driving shaft of the driving axle 16 is blocked. Therefore, if the external force that causes the reverse motion of the vehicle is unable to overcome the refraction force between tires of the vehicle and the level ground, there is no reverse motion on the vehicle. However, while the vehicle temporarily stops on the uphill or the downhill road and prepares to start moving, the restarting motion for the anti-reverse vehicle on the uphill or downhill road is as simple as the restarting motion for the anti-reverse vehicle on the level ground.

While the vehicle is driven to change to move from forward to backward on the ramp, as well as that the vehicle need to stop first, the driven wheel 5 is driven to change from the anticlockwise rotation to the clockwise rotation by the bi-directional driving pawl 4. In other words, the drive shaft of the driving axle 16 is able to clockwise rotate, such that there is no brake effect for the drive shaft of the driving axle 16.

Therefore, the anti-reverse motion device for the anti-reverse vehicle is provided to solve the drawbacks for the transmission system for the conventional vehicle so as to avoid the flameout of the engine and the reverse motion of the vehicle during the restarting action.

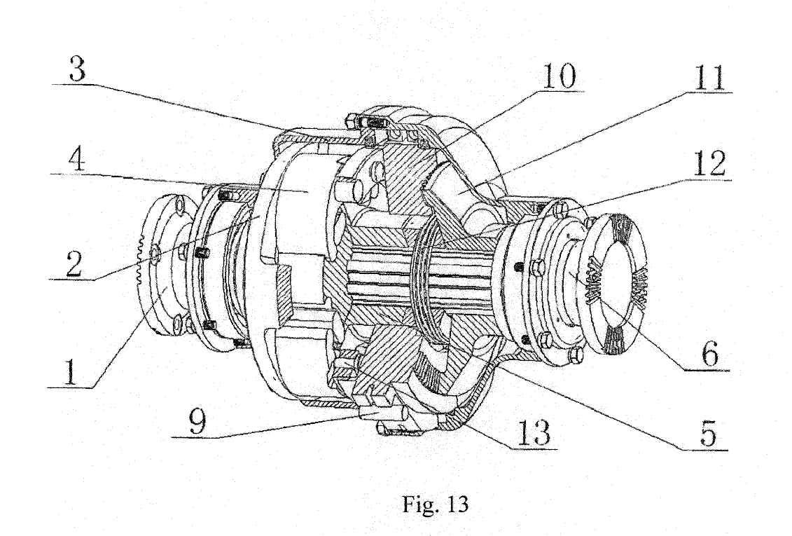

Referring to FIG. 12 to FIG. 13, an anti-reverse motion device according to a second preferred embodiment of the present invention is illustrated, which is an alternative mode of the anti-reverse motion device of the first embodiment, wherein the anti-reverse motion device is applied to a medium-size truck. Since the structure of the anti-reverse motion device is slightly different from its first embodiment, a linking tooth 11′ of the driven wheel 5′ is fixedly connected to an output shaft 6′ via the spline coupling. Accordingly, the engine power is 185 horsepower (136 kilowatt), and the speed of the engine is 2500/minutes, and the maximum loading amount is 14 tons. In addition, the transmission torque of the anti-reverse motion device is 8000 N·m, and the length of the anti-reverse motion device is 530 millimeter, and the width of the anti-reverse motion device is 360 millimeter.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

1-10. (canceled)

11. An anti-reverse motion device, comprising,
a case;
an intermittent bi-directional driving mechanism providing an intermittent stopping moment;
an unidirectional braking mechanism providing a reverse braking function; and
a linking control mechanism adapted for connecting said intermittent bi-directional driving mechanism and said unidirectional braking mechanism, wherein said unidirectional braking mechanism and said linking control mechanism are arranged within said case.

12. The anti-reverse motion device, as recited in claim 11, wherein said intermittent bi-directional driving mechanism comprising, an input shaft, an output shaft, and a set of transmission components having a driving wheel, and a driven wheel, wherein said driving wheel is fixedly connected to said input shaft, wherein said driven wheel is fixedly connected to said output shaft, wherein said driving wheel is coaxially mounted with said driven wheel; and
at least a set of bi-directional driving pawls arranged on said driving wheel to be able to swing around a position axis, wherein said driven wheel comprises at least a set of tooth spaces at a position which is corresponding with the position of said bi-directional driving pawl for meshing with said bi-directional driving pawl.

13. The anti-reverse motion device, as recited in claim 12, wherein said bi-directional driving pawls are driven by said driving wheel to operate a clockwise rotation and an anticlockwise rotation by said driving wheel, as well as that driven wheel is driven to operate a clockwise rotation and an anticlockwise rotation by said bi-directional driving pawl.

14. The anti-reverse motion device, as recited in claim 13, wherein while said driving wheel rotates at a direction, one of a set of said bi-directional driving pawl completely is driven to mesh with one of a set of said tooth space of said driven wheel, and the other of a set of said bi-directional driving pawl is completely detached from the other of a set of said tooth space so as to drive said driven wheel rotating at said direction.

15. The anti-reverse motion device, as recited in claim 12, wherein said set of transmission components comprises at least one of a locking unit arranged between each set of said bi-directional driving pawl and at least one set of latch springs arranged between said locking units and said driven wheel.

16. The anti-reverse motion device, as recited in claim 12, wherein said driving wheel is fixedly connected with said input shaft by a spline coupling, and said driven wheel is fixedly connected with said output shaft by said spline coupling.

17. The anti-reverse motion device, as recited in claim 12, wherein said unidirectional braking mechanism has a brake disk having a set of jaw linking teeth arranged thereon and a brake roller arranged between said brake disk and said case.

18. The anti-reverse motion device, as recited in claim 17, wherein while said brake disk rotates anticlockwise, a cylindrical surface of said brake roller is self-locked within inner surface of said case so as to generate said reserve braking function between said brake disk and said brake roller.

19. The anti-reverse motion device, as recited in claim 12, wherein said linking control mechanism has a brake disk having jaw linking teeth, a linking tooth arranged on said driven wheel, a return spring, and a push pin, wherein said push pin is installed within said driving wheel, wherein one of a set of said bi-directional driving pawl has a slanted working surface which contacts with one end of said push pin, and the other end of said push pin contacts with said brake disk, wherein said return spring is arranged between said braking disk and said linking tooth.

20. The anti-reverse motion device, as recited in claim 19, wherein said linking tooth of said driven wheel has meshed jaw linking teeth with respect to said jaw linking teeth of said brake disk.

21. The anti-reverse motion device, as recited in claim 20, wherein while said bi-directional driving pawl rotates anticlockwise and said driven wheel is in the intermittent stopping moment, said push pin is pushed by said slanted working surface of said bi-directional driving pawl so as to move the brake disk, such that said jaw linking teeth of said brake disk meshes with said meshed jaw linking teeth of said linking tooth in such a manner that said output shaft of said intermittent bi-directional driving mechanism is linking with said brake disk of said unidirectional braking mechanism.

22. The anti-reverse motion device, as recited in claim 20, wherein while said bi-directional driving pawl clockwise rotates and said driven wheel is in the intermittent stopping moment, said push pin loses pressing force from said slanted working surface of said bi-directional driving pawl so that said brake disk is pushed by said return spring, and said jaw linking teeth of said brake disk detached from said meshed jaw linking teeth of said linking tooth in such manner that said output shaft of said intermittent bi-directional driving mechanism is de-linking with said brake disk of said unidirectional braking mechanism.

23. The anti-reverse motion device, as recited in claim 21, wherein said anti-reverse motion device is applied to an anti-reverse motion vehicle having a vehicle frame, a driving shaft of transmission of vehicle and a driving shaft of a driving axle.

24. The anti-reverse motion device, as recited in claim 22, wherein said anti-reverse motion device is applied to an anti-reverse motion vehicle having a vehicle frame, a driving shaft of transmission of vehicle and a driving shaft of a driving axle.

25. The anti-reverse motion device, as recited in claim 23, wherein said input shaft of said intermittent bi-directional driving mechanism is connected with said transmission of the vehicle, and said output shaft of said intermittent bi-directional driving mechanism is connected with said driving axle of said vehicle, and said case of the anti-reverse motion device is fixedly arranged on said vehicle frame.

26. The anti-reverse motion device, as recited in claim 24, wherein said input shaft of said intermittent bi-directional driving mechanism is connected with said transmission of the vehicle, and said output shaft of said intermittent bi-directional driving mechanism is connected with said driving axle of the vehicle, and said case of the anti-reverse motion device is fixedly arranged on said vehicle frame.

27. The anti-reverse motion device, as recited in claim 25, wherein while said anti-reverse motion vehicle is driven to move forwardly, said output shaft of said intermittent bi-directional driving mechanism is linking with said brake disk of said unidirectional braking mechanism.

28. The anti-reverse motion device, as recited in claim 26, wherein while said anti-reverse motion vehicle is driven to move backwardly, said output shaft of said intermittent bi-directional driving mechanism is de-linking with said brake disk of said unidirectional braking mechanism.
